(19) United States
(12) Patent Application Publication
(10) Pub. No.: US 2008/0295860 A1
(43) Pub. Date: Dec. 4, 2008

(54) Apparatus and Method for Cleaning of Objects, in Particular of Thin Discs

(76) Inventor: Norbert Burger, Kirchzarten (DE)

Correspondence Address: BIOTECH BEACH LAW GROUP , PC, 625 BROADWAY, Suite 1210, SAN DIEGO, CA, 92101, US

(21) Appl. No.: 12/094,765

(22) PCT Filed: Dec. 10, 2007
(86) PCT No.: PCT/EP2007/010734

§ 371 Date: May 22, 2008

(30) Foreign Application Priority Data
Dec. 15, 2006 (DE) 10 2006 059 810.5

(51) Int. Cl. B08B 3/12; B08B 13/00

(52) U.S. Cl. 134/1; 134/199; 134/172

(57) ABSTRACT

The invention relates to an apparatus for the cleaning of thin wafers (6), wherein the wafers (6) are fixed with one side to a carrier device (2), and wherein an interspace (7) is formed between two adjacent substrates, wherein the apparatus substantially consists of a shower device (15) by which fluid is injected into the respective interspaces (7), and a basin (14) that can be filled with fluid and that is dimensioned such that it houses the carrier device (2).

According to the invention, optionally either the shower device (15) can be moved in relation to the immobile carrier device (2), or the carrier device (2) can be moved in relation to the immobile shower device (15), or both the carrier device (2) as well as the shower device (15) can be moved in relation to each other.

The method stands out by the fact that in a preferred cleaning process, a shower with warm fluid takes place at first with the carrier device (2) being moved within the basin, followed by an ultrasonic cleaning in cold fluid and another shower with warm fluid.

### TECHNICAL FIELD

The invention generally relates to an apparatus and a method for cleaning of thin discs, such as for example semiconductor wafers, glass substrates, photo masks, compact discs or the same. In particular, the invention relates to an apparatus and a method for the pre-cleaning of semiconductor wafers after these have been fabricated by sawing from a block.

### DEFINITIONS

According to the invention the term “thin discs” has to be understood to refer to such objects that have a very small thickness in the range between 80 and 300 μm, such as e.g. 150 to 170 μm. The shape of the discs is arbitrary and can e.g. be substantially round (semiconductor wafers) or substantially rectangular or quadratic (solar wafer), respectively, wherein the corners optionally can be angular, rounded, or chamfered. Due to their small thickness, these objects are very fragile. The invention relates to the pre-cleaning of such objects.

In the following, the apparatus and the method according to the invention are exemplary being explained by referring to angular solar wafers (briefly “wafers”).

However, the invention is not limited to the mere pre-cleaning of wafers. Rather, the invention generally comprises the cleaning of thin discs that are sequentially held in a carrier device with a defined distance to each other.

### BACKGROUND OF THE INVENTION

For the fabrication of wafers it is necessary to apply the starting material that usually is present in the form of a rectangular silicon block and referred to as substrate block or ingot onto a carrier device. This carrier device typically consists of a metal carrier onto which a glass plate as carrier material is mounted. The substrate block to be treated is glued onto the glass plate. Alternatively, however, other materials can also be provided for the formation of the carrier device.

For the fabrication of a plurality of wafers it is necessary to entirely saw through the substrate block that consists of mono- or polycrystalline silicon in a plate-like manner, so that the respective cut extends into the glass plate. After the sawing that is carried out e.g. by using conventional annular saws or wire saws, the wafer fabricated in this manner, due to the adhesive bond, still adheres with one long side (edge), i.e. the one that is facing the carrier device, to the glass plate. After the substrate block is completely separated into individual wafers and thus a gap-like interspace has developed between the individual wafers, the original substrate block is present in the form of a comb-like, fan-shaped object.

For carrying out the wet-mechanical sawing process by usage of a precision wire saw, substantially two materials are required; firstly, silicon carbide or equally acting particles with abrasive properties for the necessary hardness; secondly, glycol or oil as a carrier and coolant. More correctly, it is not the wire that saws the silicon, but rather the silicon carbide particles that, being admixed with glycol such as e.g. polyethylene glycol, or oil in a so-called “slurry”, are performing the actual work. During the sawing process the wire is rinsed with this medium that optionally may contain further chemical additives. By movement of the wire the particles exert their abrasive, i.e. erosive effect. As an example, by each cut with a 160 micrometer wire approximately 210 micrometers of silicon are grinded. This cutting scrap is also referred to as kerf loss; it can be reduced by usage of thinner wires with diameters of e.g. 80 micrometers. During the sawing process, a multitude of chemical reactions of the involved reactants takes place, also at the wafer surface. After sawing, slurry, reaction products and conglomerates from slurry ingredients and silicon are present between the wafers and often adhere at the wafer surface due to their consistency.

Before the individual wafers now having a disc-like shape are removed from the carrier device, a pre-cleaning takes place. By the pre-cleaning the slurry that is present in the interspaces developed between two respective substrates on the surfaces of the wafers shall be washed out. This pre-cleaning is the subject-matter of the present invention.

### STATE OF THE ART

Pre-cleanings for the removal of the slurry are known in the art. They are usually carried out manually, in that a shower head from which a fluid stream emanates is manually guided over the comb-like object. It is thus achieved that the slurry being present in the gaps of the substrate block is at least partly flushed out. However, a major part remains in the gap-like interspace.

This manual treatment is, however, difficult, since the carrier device must be showered from all sides and because the draining of the slurry is only partially possible due to the continuous turning. Furthermore, in particular the permanent turning of the carrier device bears the risk that the individual wafers break off the glass plate and are destroyed.

Until the carrier device with the wafers can be handed over to a subsequent treatment process, the surfaces of the wafers normally have already become dry. Further, slurry still adheres there, so that the following treatment process is severely affected.

A common drawback of this manual treatment relies in the fact that a constant quality and thus standardized and reproducible results regarding the surface properties cannot be assured.

### OBJECT OF THE INVENTION

The object of the present invention therefore consists in the provision of an apparatus and a method by which the slurry can at least partially be removed automatically from the interspaces of adjacent thin discs.

### SOLUTION

The basic principle of the invention is to provide an apparatus and a method by which the cleaning process being organized in different process steps can be run through in a self-acting manner (automatically).

The apparatus according to the invention is subject-matter of claim 1, while the method according to the invention is defined by the features of claim 11. Preferred embodiments are subject of respective subclaims.

### ADVANTAGES OF THE INVENTION

In order to allow for a largely removal of the slurry out from the interspaces, an apparatus is proposed that substantially consists of a carrier device, a shower device, and a basin.

The carrier device that at least consists of the carrier material onto which the substrate block is applied comprises the thin discs (such as e.g. wafers) produced by sawing of the substrate block. These are arranged sequentially, i.e. one after another, wherein a respective interspace is formed between the individual wafers. The shower device is designed in such a manner that it generates a fluid stream mainly into the interspaces and preferably along the entire length of the wafers. The entire cleaning process is intended to take place within a basin that can be filled with fluid. The basin is appropriately dimensioned such that the carrier device completely fits into it.

During the shower process the basin is not filled. It rather serves for collecting and draining the fluid streaming through the wafers. According to a preferred embodiment, the shower process takes place in a basin whose fluid level is adjusted in such a manner that the lower part of the substrate block (10 to 50%, particularly preferred approx. 30% of the wafer surface) is within the fluid.

The initial position of the cleaning process is defined in that the carrier device is handed over to a “basket-like” auxiliary device of the apparatus according to the invention. Basically, the design of this auxiliary device is not predetermined as long as it is assured that the fluid can reach the interspaces between the wafers substantially unhindered and that the substrate blocks as well as possibly detached substrates are held securely. According to a preferred embodiment, this device is provided in form of two rod pairs running parallel to each other in longitudinal direction, wherein one pair serves as a support and a further pair backs the wafers from the side. As soon as the auxiliary device is brought into the apparatus, the comb-like object of the substrate block being fixed onto the carrier device is oriented in such a manner that the interspaces are open and therefore freely accessible both towards the sidewalls and towards the bottom of the basin. In this initial position, the carrier device is located above the substrates being carried by it.

The first step of the cleaning process according to the invention that is set forth in the following can advantageously be preceded by a glycol pre-storage of the substrates to be treated.

For the first step of the cleaning process according to the invention it is intended to activate a shower device. According to the invention, the shower device comprises at least one shower element being designed in a two-part configuration, wherein one respective part is arranged laterally at a long side of the basin in such a manner that both parts run parallel to the longitudinal axis of the basin and, with respect to their flow direction, are positioned in opposing directions. Therefore, the shower device is designed in such a manner that the fluid stream is directed into the respective interspaces of adjacent wafers, rinsing away the impurities. The at least one shower element or one part of the two-part shower element, respectively, is equipped with a plurality of nozzles (openings of boreholes) that are functionally connected to each other via at least one nozzle bar so that they can therefore be fed by the same fluid volume. Depending on the length of the substrate block to be treated and the feed pressure at hand, the shower element can be divided into several segments on both sides, wherein each of them is characterized by the presence of one respective nozzle bar. The position of both parts of the shower element can (if desired, separately from each other) be adjusted. The vertical height as well as the distance of the shower element or of one of its parts or segments to the side wall of the basin can be changed. Further, the shower element or one of its parts or segments can be moved in parallel to the lateral basin wall. If desired, the at least one nozzle bar that is arranged along one side of the basin can fulfil an oscillating movement that can optionally be directed in the up-and-down direction, against towards or away from the basin wall, and/or forth and back parallel to the basin wall. Advantageously, possible inhomogeneities of the flow characteristic can thus be compensated. A further advantage of the oscillation parallel to the axis of the nozzle bar is to avoid differing flow characteristics as they can occur e.g. due to clogging of individual nozzles. By these movements, substrate clusters that extremely adhere to each other are put into oscillation, thereby enhancing the cleaning of the interspaces of such clusters. If according to the invention a plurality of shower elements is present or used, these are arranged on different levels with respect to the depth of the basin.

Preferably, the nozzle bar is designed rectangular, wherein the upper and/or lower region of the side pointing towards the opposite basin wall is particularly preferred chamfered to the back, so that the nozzles being arranged in these chamfered regions are slightly oriented up- or downwards, resulting in that they cannot emit parallel to the nozzles arranged in the middle region. By the chamfered regions it is achieved that dirt spots located between two adjacent substrates can be removed even more efficiently. Preferably, the nozzle bars each provide at least one flow breaker, by which a most possible homogenous flow characteristic over the entire nozzle bar is achieved.

The nozzle holes are preferably not circular, but rather oval or most preferred star shaped, and have a preferred cross sectional area of 0.1 to 0.5, most preferred of 0.2 mm², wherein they are preferably designed in such a conical shape that the diameter at the outlet is approx. 0.3 mm smaller than the one at the entry. The geometry of the nozzle holes preferably allows for the drag-in of gas into the fluid stream, thereby achieving positive effects on the cleaning results. Preferably, the nozzles in a respective nozzle bar are arranged in columns and rows, wherein the columns are preferably spaced 4 mm, and the rows are preferably spaced 3 mm from each other. Most preferably, the geometry of the nozzles is such that a most possible far-reaching (e.g. 400 mm) fluid jet is generated that has a preferred diameter of approx. 1 mm and still is turbulent even when low flow speeds are applied. In this way, the effect of the jet on the object is “soft”.

According to a preferred embodiment the nozzle bars present on both sides of the at least one shower element are controlled in such a manner that the fluid is emitted only on one side, while the nozzles on the other side do not emit fluid. After a short period of treatment, the sides are changed, so that the fluid is directed at the substrate block alternating from the left or the right, respectively. If one part of the shower element (one side) comprises a plurality of segments each having a nozzle bar, it must preferably be assured also here that directly opposing nozzles are not activated simultaneously. To the one skilled in the art it is clear that this can be achieved in different ways. For example, all nozzles of all present nozzle bars on one side are activated, while the entirety of the nozzles on the opposite side is not activated. Alternatively, the nozzles or nozzle bars of adjoining segments are controlled in such a manner that directly adjoining segments are not activated simultaneously, wherein also here with both sides in mind it must be assured that directly opposing nozzles, nozzle bars or segments are not activated simultaneously. By this alternating control an optimal cleaning is achieved.

Further, means are provided that transport a fluid to the at least one shower element. As process parameters, amongst others, the amount of fluid (or liquid, respectively) and its flow speed are determinant for the cleaning process. Both parameters can be varied by suitable means known in the art. According to the invention, the pressure of the fluid for the entirety of the openings of one shower element can be adjusted to a value between 0.1 and 1.0 bar, preferably to a value between 0.2 and 0.5 bar.

Preferably in addition to the above-mentioned movements of the at least one shower element or of one of its parts or segments, optionally either the shower device is moved in relation to the immobile carrier device, or the carrier device is moved in relation to the immobile shower device in order to remove the slurry from the interspaces during the cleaning process. Alternatively it also can be provided that both the carrier device and the shower device are moved in relation to each other.

In order to allow the fluid stream flowing through the interspaces, the carrier device is positioned in such a manner that the respective open sides point towards both side walls of the basin and in direction of the bottom of the basin. By the alternating, i.e. one-side-or-the-other activation of the shower device according to the invention it is achieved that the slurry is rinsed out of the interspaces from the one as well as from the other side.

By means of an increased volume flow of the fluid, the further advantage arises that the wafers that stick together at their free ends are held in a distance to each other.

A further advantage of an increased volume flow consists in that the wafers at least slightly vibrate, so that slurry adhering to a surface of a wafer can come off more easily.

For optimization of the cleaning process there is provided at last one ultrasonic device that is arranged within the basin and optionally is immobile or movable. Further, the ultrasonic sources can be arranged or directed inclined or parallel to the wafers. This cleaning process advantageously follows directly to the cleaning process with the at least one shower element. For carrying out this process it is necessary that the basin in which the carrier device is arranged is filled with fluid. Preferably, a cold fluid is used in order to enable an optimal transfer of the ultrasonic waves. Preferably, the temperature is adjusted to a value between 15 and 25° C. in order to prevent chemical reactions and to ensure an essentially mechanical treatment.

The cleaning process with ultrasonic waves preferably can be supported by at least one immobile or movable cross flow device for the generation of a fluid stream within the basin, wherein the above-mentioned shower device with its at least one shower element exercises the function of this cross flow device. Thus, the cross flow device is formulated such that the fluid stream is directed into the respective interspaces of two adjacent wafers, thereby rinsing away the particles loosened by the ultrasound. The at least one cross flow device or one part of the two-part device, respectively, has a plurality of nozzles (openings or boreholes) that are functionally connected to each other via at least one nozzle bar and can thus be fed by the same fluid volume. Depending on the length of the substrate block to be treated and on the feed pressure at hand, the cross flow device may on both sides be divided into several segments, wherein each of them is characterized by the presence of one nozzle bar. The position of both parts of the cross flow device is (if necessary, separately from each other) adjustable. The height as well as the distance of the cross flow device or of one of its parts or segments to the basin wall is changeable. Further, the cross flow device or one of its parts or segments can be moved in parallel to the lateral basin wall. Preferably, the cross flow device is only activated when its nozzles are located below the fluid level. If desired, the at least one nozzle bar that is arranged at one side of the basin can execute an oscillating movement that can optionally be directed in the up-and-down direction, against to or away from the basin wall, and/or forth and back parallel to the basin wall. In this way, location-independent fluid eddies advantageously may develop and can be used. A further advantage of the oscillation parallel to the axis of the nozzle bar is the avoidance of differing flow characteristics as they can occur e.g. due to clogging of individual nozzles. By this movement, clusters of substrates that extremely adhere to one another are set vibrating, thereby improving the cleaning of the interspaces of such clusters. If, according to the invention, a plurality of cross flow devices is present or used, these are arranged on different levels with respect to the depth of the basin.

Preferably, the nozzle bar is designed rectangular, wherein the upper and/or lower region of the side that points towards the opposite basin wall is chamfered particularly preferred to the back, so that the nozzles that are arranged in the chamfered regions are slightly adjusted up- or downwards and thus not cannot emit parallel to the nozzles arranged in the middle region. By the chamfered regions it is achieved that dirt spots located between two adjacent substrates can be removed even more efficiently. Preferably, the nozzle bars have flow breakers, by which a most possible homogenous flow characteristic over the entire nozzle bar is achieved.

Preferably, the nozzle holes are not circular, but rather oval or most preferred star shaped, and have a preferred cross sectional area of 0.1 to 0.5, most preferred of 0.2 mm², wherein they are preferably designed in such a conical shape that the diameter at the outlet is approx. 0.3 mm smaller than the one at the entry. The geometry of the nozzle holes preferably allows for the drag-in of gas into the fluid stream, thereby achieving positive effects on the cleaning results. Preferably, the nozzles in a respective nozzle bar are arranged in columns and rows, wherein the columns are preferably spaced 4 mm, and the rows are preferably spaced 3 mm from each other. Most preferably, the geometry of the nozzles is such that a most possible far-reaching (e.g. 400 mm) fluid jet is generated that has a preferred diameter of approx. 1 mm and still is turbulent even when low flow speeds are applied. In this way, the effect of the jet on the object is “soft”.

According to a preferred embodiment the nozzle bars present on both sides of the cross flow device are controlled in such a manner that the fluid is emitted only on one side, while the nozzles on the other side do not emit fluid. After a short period of treatment, the sides are changed, so that the fluid is directed at the substrate block alternating from the left or the right, respectively. If one part of the cross flow device (one side) according to the invention comprises a plurality of segments each having a nozzle bar, it must preferably be assured also here that directly opposing nozzles are not activated simultaneously. By this alternating control an optimal cleaning is achieved.

After the ultrasonic treatment of the substrate block the basin is emptied, and another cleaning process with the at least one shower element begins. Depending on the requirements the process can be repeated by changing between the cycles “cleaning process with shower element” and “cleaning process with ultrasound”.

According to a particular embodiment of the invention the substrate block is firstly cleaned by means of the shower device with a warm fluid that, if desired, contains suitable chemical additives such as e.g. surfactants, wherein its temperature preferably is between 35 and 40° C. Subsequently, the ultrasonic cleaning takes place within a cold fluid. Both processes recur, if necessary. As a final process, there is provided a cleaning process that uses the shower device with a cold fluid. The latter has the advantage that the showering with a cold fluid prevents the wafers from drying out, eventually causing remaining slurry to firmly adhere to the wafers.

According to the invention, the showering fluid is aqueous and preferably adjusted to a temperature between 15 and 40° C., wherein a temperature between 30 and 40° C. is particularly preferred. Preferably, it comprises suitable non-foaming, non-ionic surfactants in an amount of 0 to 1 vol. %, wherein an amount of 0.1 to 0.5 vol. % with respect to the entire fluid volume is particularly preferred. Preferably, the surfactant(s) have a (mean) pH-value of approx. 13.0, so that the pH-value of the shower fluid advantageously can be adjusted to a preferred value less than 12.0, and to a particularly preferred value between 10.5 and 11.0. Further, the shower fluid can comprise base or acid as well as further chemicals, if desired.

If desired, the method of a preferred embodiment according to the invention can comprise an additional process step of glue removal. For this purpose, the carrier device and, if necessary, the auxiliary device are transferred into a treatment tank that contains a liquid which is appropriate with respect to the composition of the glue used. For example, the use of an aqueous fluid containing acetic acid has proven to be particularly suitable, wherein it is particularly preferred that its temperature and pH-value are adjusted to values around 40° C. or 3.0 to 4.0, respectively. Subsequently, the wafers are rinsed, what preferably takes place by transferring them with the auxiliary device into a water filled rinsing tank.

A further essential advantage of the method is that it can easily be integrated into a subsequent treatment process of the wafers. It has proven particularly advantageous that according to the invention the process parameters can be adjusted exactly and reproducible, whereby also the treatment of large quantities with a constant quality level is enabled.

Further advantageous embodiments are given in the following description as well as in the figures and in the claims.

### FIGURES

FIG. 1 shows a schematic view of the carrier device 2, essentially consisting of the substrate block 1 to be cleaned;

FIG. 2 shows a perspective view of an auxiliary device 8 for the reception of the carrier device 2 according to FIG. 1;

FIG. 3 shows a perspective view of an auxiliary device 8, in contrast to FIG. 2 already being loaded with the carrier device 2;

FIG. 4 shows a schematic view of a preferred embodiment of the apparatus according to the invention with shower device in form of a two-part shower element 16;

FIG. 5 shows a schematic view of a preferred embodiment of the apparatus according to the invention with shower element 16 or cross flow device 17, respectively, but in contrast to FIG. 4 already with inserted carrier device in initial position (A); shows a schematic view of a further preferred embodiment with a more detailed representation of ultrasonic device 18 and shower element 16 or cross flow device 17, respectively, being arranged on both sides (B).

### DESCRIPTION OF AN EXEMPLIFYING EMBODIMENT

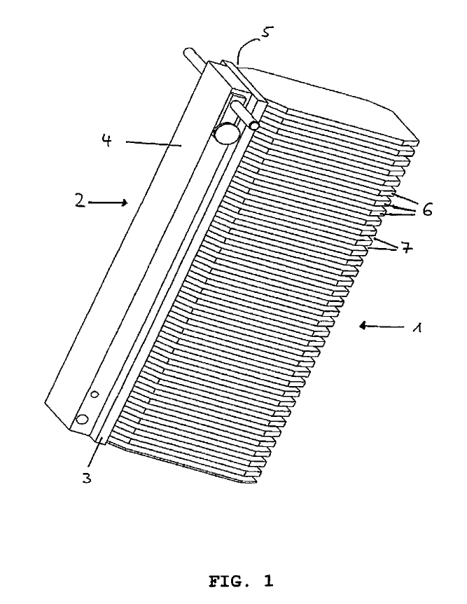

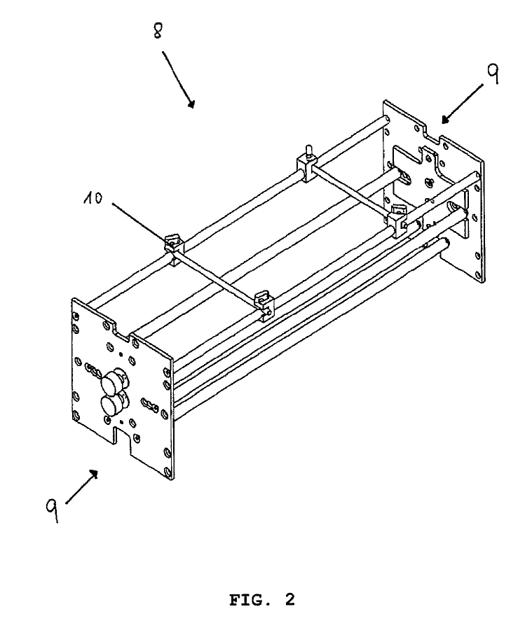

In FIG. 1 a substrate block 1 to be cleaned is depicted. The substrate block 1 is mounted onto a carrier device 2 that consists of a glass plate 3 and a mounting element 4. In this embodiment, the substrate block with its one side 5 1 is glued planar onto the glass plate 3. The already performed sawing process whose cuts reach into the glass plate 3, results in the formation of individual substrates that are also referred to as wafers 6. Between the individual wafers 6 a respective interspace 7 develops in which the so-called slurry (not shown in the figures) is present that shall be removed by the cleaning process according to the invention.

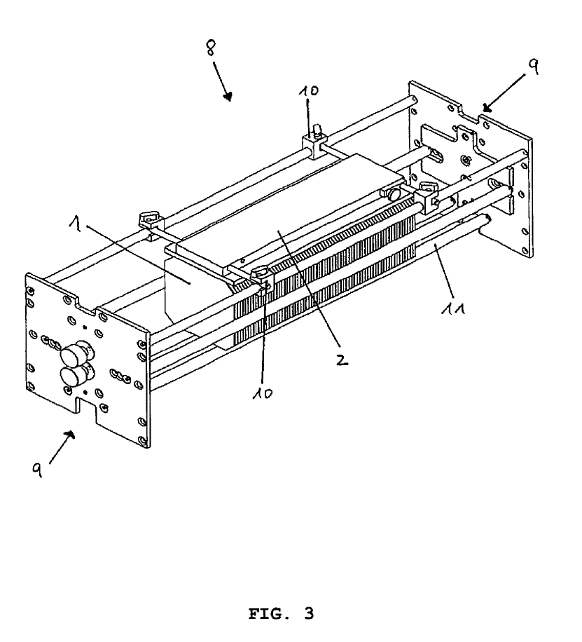

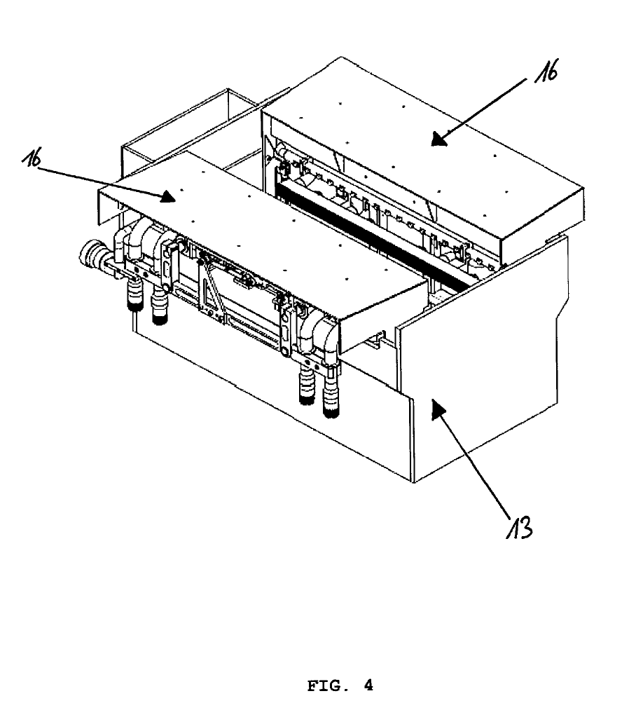

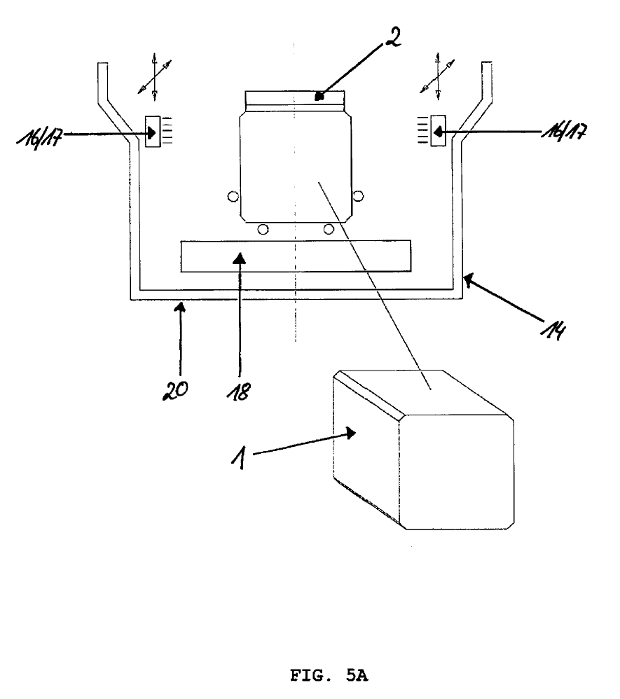

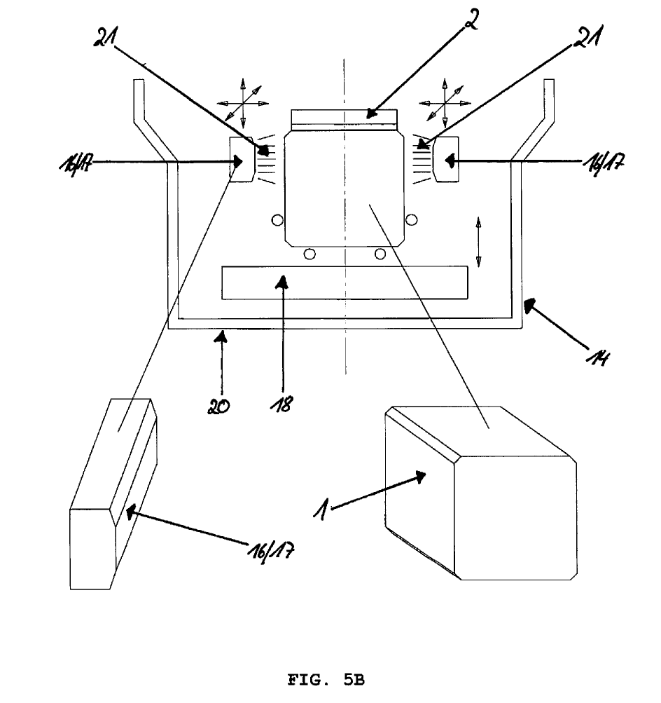

In order to transfer the substrate block 1 that is connected with the carrier device 2 to the apparatus according to the invention as depicted in FIGS. 4 and 5, the carrier device 2 is transferred with an auxiliary device 8 as depicted in FIGS. 2 and 3. Preferably, the auxiliary device 8 comprises laterally arranged means 9 that interact with the apparatus according to FIGS. 4 and 5. In order to allow reception of differently sized carrier devices 2, there is provided a reception device 10 that can be flexibly positioned for reception of the carrier device 2. Furthermore, the auxiliary device 8 is designed in such a manner that the substrate block 1, as depicted in FIG. 3, takes a position that protects against unwanted collision with an object. In the exemplary embodiment represented here, rods 11 are arranged as connection elements between the provided means 9 that enclose the substrate block 1 in between them.

In order to carry out the cleaning process, the apparatus 12 is loaded with the auxiliary device 8, as shown in FIG. 5. The apparatus 12 itself has a housing 13 that comprises a basin 14 that can be filled with a fluid. The basin 14 is dimensioned such that the auxiliary device 8 can entirely be taken up by the basin 14.

Preferably, the basin 14 is designed in such a manner that it can receive the auxiliary device 8 at the respective means 9.

The apparatus 12 further comprises a shower device 15. The shower device 15 substantially consists of a shower element 16 that is designed in two parts and runs in parallel to the longitudinal extension of the carrier device 2.

In the exemplary embodiment depicted in FIG. 5, the shower element is used as cross flow device 17 during the ultrasonic treatment. This cross flow device, thus also having a two-part design, has nozzle-like means that generate a cross flow within the basin 14 for the cleaning of the substrate block 1.

Further, an ultrasonic device 18 with ultrasonic sources is provided at the bottom side of the housing 13. According to the needs, this ultrasonic device 18 is switched on or off, and it serves for additionally loosening or removing the slurry that is present in the interspaces.

As an alternative to the ultrasonic device 18 depicted in FIG. 5, a mobile ultrasonic device that also within the basin 14 can be moved to any position may be provided instead of the stationary immobile mounting.

### Operating Principle:

The cleaning process is as follows:

After the carrier device 2 together with the auxiliary device 8 has been introduced into the apparatus 12 (FIG. 5), the carrier device 2 takes a position by which the individual wafers 6 are directed towards the bottom 20. This means that the interspaces 7 each are open to the sides and in direction of the bottom 20 of the basin 14.

The cleaning process starts by activation of the shower device 15. The fluid stream 21 that exits the shower element 16 enters into the respective interspaces 7, passes through them at least partially, before it re-exits in the direction of the bottom 20 of the basin 14. Due to the processing according to the invention as set forth in detail above, the slurry can be removed from the respective interspaces 7. Depending on the degree of contamination, this cleaning process can be repeated as often as desired. The fluid stream 21 itself is preferably temperature controlled and can exhibit temperatures between 25 degrees and 40 degrees Celsius.

According to a preferred embodiment, an ultrasonic cleaning with the ultrasonic device 18 subsequently takes place. For this, it is necessary that the basin 14 is filled with a fluid in order to transmit the sound waves from the ultrasonic sources.

Subsequently, the basin 14 is emptied and the already described shower process starts.

In this manner, the individual steps can be repeated as often as desired.

Before the removal of the then pre-cleaned substrate block 1, preferably a shower process takes place again; however, with a cold fluid. Thus, it can be prevented that remaining slurry, at least directly, dries onto the wafers.

By means of the apparatus 1 according to the invention and by carrying out the method according to the invention it has become possible to pre-clean thin, fragile discs automatically. Particularly in the fabrication of wafers for the semiconductor and solar industry it is necessary to remove the so-called slurry immediately after the sawing process. This slurry very firmly adheres to the surface of the respective wafer, so that a manual treatment had to be carried out up to now. However, by means of the method according to the invention is has become possible to enable a high quality and automatic pre-cleaning of the wafers 6.

The present invention was disclosed in view of the treatment of silicon wafers. As a matter of course, disc-shaped substrates made from other materials such as e.g. from plastics can also be treated according to the invention.

### LIST OF REFERENCE NUMBERS

1. substrate block
2. carrier device
3. glass plate
4. mounting element
5. one side
6. wafer
7. interspace
8. auxiliary device
9. means
10. reception device
11. rods
12. apparatus
13. housing
14. basin
15. shower device
16. shower element
17. cross flow device
18. ultrasonic device
19. ultrasonic sources
20. bottom
21. fluid stream

1. Apparatus for the cleaning of thin wafers (6), wherein the wafers (6) are fixed with one side to a carrier device (2), and wherein an interspace (7) is formed between two adjacent wafers (6), substantially consisting of:
a shower device (15), by which fluid is injected into the respective interspaces (7), and
a basin (14) that can be filled with fluid and that is dimensioned such that it houses the carrier device (2),
characterized in that the shower device (15) comprises at least one shower element (16) having a plurality of nozzles and a two-part design with each respective part being arranged laterally at one long side of the basin (14) in such a manner that both parts run parallel to the longitudinal axis of the basin and, with respect to their flow direction, are positioned in opposing directions, and wherein both parts of the at least one shower element (16) are controllable in such a manner that directly opposing nozzles are not activated simultaneously.

2. Apparatus according to claim 1, characterized in that the nozzles are functionally connected to each other via at least one nozzle bar so that they can therefore be fed by the same fluid volume.

3. Apparatus according to claim 1, characterized in that the at least one shower element (16) is divided into several segments on both sides, wherein each of the segments has one nozzle bar.

4. Apparatus according to claim 1, characterized in that the position of both parts of the shower element (16) is (if necessary, separately from each other) adjustable.

5. Apparatus according to claim 1, characterized in that either the shower device (15) can be moved in relation to the immobile carrier device (2), or the carrier device (2) can be moved in relation to the immobile shower device (15), or the carrier device (2) as well as the shower device (15) can be moved in relation to each other.

6. Apparatus according to claim 1, characterized in that at least one ultrasonic device (18) is provided that is arranged within the basin (14) optionally immobile or movable.

7. Apparatus according to claim 1, characterized in that several shower elements (16) are arranged on different levels with respect to the depth of the basin (14).

8. Apparatus according to claim 1, characterized in that the least one shower element (16) is vertically adjustable within the basin (14).

9. Apparatus according to claim 6, characterized in that the ultrasonic device (18) comprises ultrasonic sources (19) that are arranged inclined to the horizontal orientation of the carrier device (2).

10. Apparatus according to claim 6, characterized in that the ultrasonic sources (19) are arranged rotating.

11. Method for the cleaning of thin wafers (6) by means of an apparatus, wherein the wafers (6) are fixed with one side to a carrier device (2), and wherein an interspace (7) is formed between two adjacent wafers, and wherein the apparatus substantially consists of a shower device (15) by which fluid is injected into the respective interspaces (7), and a basin (14) that can be filled with fluid and that is dimensioned such that it houses the carrier device (2), characterized by the following process steps:
a) insertion of the carrier device (2) with the substrate block (1) into the empty or partly filled basin (14);
b) carrying out of the cleaning process with the shower device (15);
c) carrying out of the cleaning process with the ultrasonic device (18) in the presence of fluid.

12. Method according to claim 11, characterized in that the shower device (15) comprises at least one shower element (16) having a plurality of nozzles and a two-part design with each respective part being arranged laterally at one long side of the basin (14) in such a manner that both parts run parallel to the longitudinal axis of the basin and, with respect to their flow direction, are positioned in opposing directions, and wherein both parts of the at least one shower element (16) are controllable in such a manner that directly opposing nozzles are not activated simultaneously.

13. Method according to claim 11, characterized in that the process step b) is carried out before and after the process step c).

14. Method according to claim 11, characterized in that the process steps b) and c) are carried out several times one after the other.

15. Method according to claim 11, characterized in that the process step b) is carried out with a warm fluid.

16. Method according to claim 11, characterized in that the process step c) is carried out with a cold fluid.

17. Method according to claim 11, characterized in that the last cleaning process comprises carrying out of the cleaning process with the shower device (15) using a cold fluid.
